(19) United States
(12) Patent Application Publication
(10) Pub. No.: US 2020/0270485 A1
(43) Pub. Date: Aug. 27, 2020

(54) WATER-ACTIVATED TAPES

(71) Applicant: 3M INNOVATIVE PROPERTIES COMPANY, St. Paul, MN (US)

(72) Inventors: Jayshree Seth, Woodbury, MN (US); Scott M. Tapio, Falcon Heights, MN (US); Stephen J. Kuncio, St. Paul, MN (US); David T. Amos, St. Paul, MN (US)

(21) Appl. No.: 16/462,082

(22) PCT Filed: Nov. 17, 2017
(86) PCT No.: PCT/IB2017/057213

§ 371 Date: May 17, 2019

Related U.S. Application Data
(60) Provisional application No. 62/424,095, filed on Nov. 18, 2016.

(51) Int. Cl. C09J 7/32; C09J 7/50; C09J 7/29; C09J 7/38

(52) U.S. Cl. CPC C09J 7/32; C09J 7/50; C09J 7/29; C09J 7/385; C09J 2423/003; C09J 2203/30; C09J 2403/00; C09J 2431/00; C09J 2423/10; C09J 2467/00; C09J 2477/00; C09J 2433/003

(57) ABSTRACT

A water-activated tape including: a laminate that includes a paper layer and a polymeric reinforcement film layer bonded to the paper layer; a primer coating disposed on the polymeric reinforcement film layer of the laminate; and a water-activatable adhesive layer disposed on the primer-coated surface of the polymeric reinforcement film.

### BACKGROUND

Filament- or fiber-reinforced water-activated tapes (WAT), also referred to as gummed paper tapes, are often used for sealing cartons in e-commerce fulfilment. The fiber reinforcements provide strength to the paper tape but lead to several drawbacks. Such drawbacks include, for example, a higher manufacturing cost, thicker and non-flat product, which limits the yardage on a roll, compromises ease of opening for the consumer, and can cause recycling issues. What is needed are tapes that retain the performance and positive aesthetic attributes of conventional fiber-reinforced constructions but are thinner and flatter, and easy to open by the consumer without causing downstream recycling issues.

### SUMMARY

The present disclosure provides a water-activated tape that includes a water-activatable adhesive. Such non-fiber-reinforced water-activated tapes are suitable packaging tapes for e-commerce.

In one aspect, the water-activated tape includes: a laminate that includes a polymeric reinforcement film layer having two major surfaces, and a paper layer bonded to one major surface of the polymeric reinforcement film; a primer coating disposed on the major surface of the polymeric reinforcement film layer of the laminate opposite the paper layer; and a water-activatable adhesive layer disposed on the primer-coated surface of the polymeric reinforcement film.

In the context of an adhesive, “water-activatable” refers to an adhesive that is dried out of water, which when subsequently remoistened with water becomes tacky and gum-like. That is, it is able to be activated by water. This class of adhesives is also called gum adhesives or remoistenable adhesives.

The term “room temperature” refers to a temperature of about 20° C. to about 25° C.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits under certain circumstances. Other embodiments may also be preferred, however, under the same or other circumstances. Furthermore, the recitation of one or more preferred embodiments does not imply that other embodiments are not useful, and is not intended to exclude other embodiments from the scope of the disclosure.

Terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements (e.g., preventing and/or treating an affliction means preventing, treating, or both treating and preventing further afflictions).

Various sets of numerical ranges (for example, of the number of carbon atoms in a particular moiety, of the amount of a particular component, or the like) are described, and, within each set, any lower limit of a range can be paired with any upper limit of a range. Such numerical ranges also are meant to include all numbers subsumed within the range (for example, 1 to 5 includes 1, 1.5, 2, 2.75, 3, 3.80, 4, 5, and so forth).

All numbers herein are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above Summary section is not intended to describe every embodiment or every implementation of the disclosure. The detailed description that follows more particularly describes illustrative embodiments. Throughout the detailed description, guidance is provided through lists of examples, which examples can be used in various combinations. In each instance, a recited list serves only as a representative group and should not be interpreted as being an exclusive list.

### FIGURES

FIG. 1 is a water-activated tape of the present disclosure.

### DETAILED DESCRIPTION

The present disclosure provides a water-activated tape that includes a film-paper laminate backing with a water-activatable adhesive disposed thereon. The film-paper laminate tapes of the present disclosure retain performance and positive aesthetic attributes of conventional fiber-reinforced constructions, while being thinner and flatter, which facilitates larger rolls while reducing downstream recycling issues. The film-paper laminate tapes of the present disclosure also provide a robust closure with an easier to open tape.

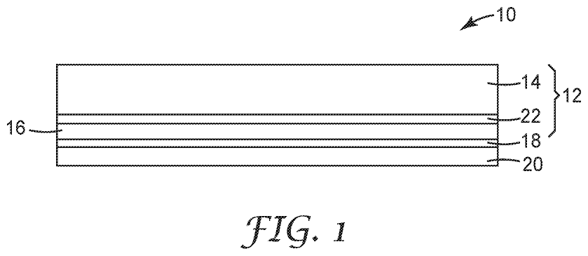

Referring to FIG. 1, the water-activated tape 10 includes: a laminate 12 that includes a paper layer 14 and a polymeric reinforcement film layer 16 bonded to the paper layer; a primer coating 18 disposed on the polymeric reinforcement film layer 16 of the laminate 12; and a water-activatable adhesive layer 20 disposed on the primer-coated surface of the polymeric reinforcement film. That is, the polymeric reinforcement film has two major surfaces—one major surface has the primer coating thereon and the other major surface is bonded to the paper layer. In certain embodiments, the paper layer 14 and the polymeric reinforcement film layer 16 are bonded together with an adhesive 22.

The backing for the water-activatable adhesive layer is a laminate of a paper and a polymeric reinforcement film layer.

A wide variety of papers can be used in the backing laminate. In certain embodiments, the paper layer includes, but is not limited to, a creped paper, a non-creped paper, or a release paper. In certain embodiments, the paper layer includes a Kraft paper (e.g., a creped NBSK (Northern Bleached Softwood Kraft), such as a 20 to 57 pound Kraft paper). An exemplary Kraft paper is available under the trade designation 40 pound MF from Expera Specialty Solutions, Mosinee, Wis. If desired, the paper can include text and/or graphics printed thereon.

In certain embodiments, the paper layer has a thickness of at least 25 micrometers. In certain embodiments, the paper layer has a thickness of up to 200 micrometers.

A wide variety of polymeric reinforcement film layers can be used in the backing laminate. In certain embodiments, the polymeric reinforcement film layer includes an oriented polymeric film, which may be biaxially oriented or monoaxially oriented. In certain embodiments, the polymeric reinforcement film layer is biaxially oriented.

In certain embodiments, the polymeric reinforcement film layer includes a polyolefin, a nylon, a polyester, or a co-polyester. In certain embodiments, the polymeric reinforcement film layer includes biaxially oriented polypropylene (BOPP), biaxially oriented polyethylene terephthalate (BOPET), or biaxially oriented polylactide (BOPLA). An exemplary BOPP film is available under the trade designation ELITE 5230G from Dow Chemical. An exemplary PET film is available under the trade designation MELINEX 453 from DuPont Teijin Films US, Chester, Va. An exemplary PLA film can be made from polymer 4032D, a NatureWorks LLC (Minnetonka, Minn., and a commercially available biaxially oriented polylactide film (BOPLA) is one available under the trade designation BI-AX 40-EV (40 μm thick film) from Biax International Inc., Tiverton, Ont.

In certain embodiments, the polymeric reinforcement film layer includes an additive selected from a UV inhibitor, antioxidant, pigment, and antistatic agent. Such additives are well known to those skilled in the art.

In certain embodiments, the polymeric reinforcement film layer has a thickness of at least 0.5 mil (0.0005 inch or 12.7 micrometers), or at least 1.0 mil (0.001 inch or 25 micrometers). In certain embodiments, the polymeric reinforcement film layer has a thickness of up to 2 mils (0.002 inch or 50.8 micrometers).

In certain embodiments, the paper layer and the polymeric reinforcement film layer are bonded together through extrusion lamination to form the laminate. Alternatively, in certain embodiments, the paper layer and the polymeric reinforcement film layer are bonded together with an adhesive.

For the adhesive that bonds the polymeric reinforcement film layer and the paper layer, those skilled in the art will be able to select suitable adhesives, for example and without limitation, hot melt adhesives, heat activated adhesives, or pressure sensitive adhesives (PSAs), as described herein.

Illustrative suitable tackified rubber hot melt adhesives are disclosed in U.S. Pat. No. 4,125,665 (Bemmels et al.) and U.S. Pat. No. 4,152,231 (St. Clair et al.). Illustrative suitable acrylic hot melt adhesives are disclosed in U.S. Pat. No. 4,656,213 (Schlademan) and U.S. Pat. No. 5,804,610 (Hamer et al.). Further illustrative adhesives that may be applied as hot melt adhesives suitable for use in the tapes of the disclosure are disclosed in U.S. Pat. No. 8,492,486 (Sherman), U.S. Pat. No. 8,202,934 (Sherman), and U.S. Pat. No. 7,084,209 (Everaerts).

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky. Examples of suitable heat activated adhesives include polyacrylate hot melt adhesives, polyvinyl butyrals, ethylene vinyl acetate, ionomers, polyolefins, or combinations thereof.

Pressure sensitive adhesive (PSA) compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. Obtaining the proper balance of properties is not a simple process. Pressure sensitive adhesives useful in the present disclosure include tackified natural rubbers, synthetic rubbers such as tackified styrene copolymers (e.g., styrene/butadiene copolymers (SBR) and styrene/isoprene/styrene (SIS) block copolymers), polyvinyl ethers, acrylics (e.g., various (meth)acrylate (acrylate and methacrylate) copolymers, including emulsion-based acrylic PSAs), poly-alpha-olefins, and silicones. Illustrative pressure sensitive adhesives that are suitable for use in the disclosure are described, for example, in U.S. Pat. Appl. Pub. Nos. 2013/0337260 (Tapio et al.), 2013/0316076 (Sherman), 2012/0295025 (Sherman et al.), 2012/0100326 (Sherman et al.), and 2009/0161058 (Sherman). Suitable adhesives can also be prepared from water-based latex compositions formed by emulsion polymerization. Such adhesives are described, for example, in U.S. Pat. No. 5,686,518 (Fontenot et al.), U.S. Pat. No. 6,710,128 (Helmer et al.), U.S. Pat. No. 6,511,744 (Centner et al.), U.S. Pat. No. 6,048,611 (Lu et al.), U.S. Pat. No. 4,912,169 (Whitmire et al.), U.S. Pat. No. 6,657,011 (Lau et al.), U.S. Pat. No. 8,258,240 (Suzuki et al), and U.S. Pat. App. Pub. No. 2010/0081764 (Ouzineb et al.).

Thus, in certain embodiments, the water-activated tape of the present disclosure includes a pressure sensitive adhesive to bond the paper layer and the polymeric reinforcement film layer. In certain embodiments, the pressure sensitive adhesive is an acrylic-based pressure sensitive adhesive (including emulsion-based acrylic PSAs) for bonding the paper layer to the polymeric reinforcement film layer to form the tape backing laminate.

Techniques for preparing a backing that includes a paper layer laminated to the polymeric reinforcement film layer are well known to those skilled in the art. A representative technique is described in the Examples Section.

A primer coating is disposed on a major surface of the polymeric reinforcement film layer of the backing laminate (opposite the major surface to which the paper layer is bonded), and a water-activatable adhesive layer is disposed on the primer-coated surface of the polymeric reinforcement film.

In certain embodiments, the polymeric reinforcement film layer is corona treated prior to primer coating. Techniques for corona treating, particularly air-corona treating, a polymeric reinforcement film layer are well known to those skilled in the art. A representative technique is described in the Examples Section.

In certain embodiments, the primer coating includes one or more adhesion promoters, which may be film-forming polymers or low molecular weight compounds, and optionally one or more additives. Exemplary polymers of the primer coating may have a wide range of molecular weights (e.g., 10,000-500,000 Daltons). Exemplary polymers of the primer coating have a wide range of glass transition temperatures (e.g., T_{g} of −30° C. to 40° C.). The molecular weight and T_{g} are not particularly limiting for selection of materials of the primer coating. These are merely exemplary values.

Examples of adhesion promoters of the primer coating include, but are not limited to, include a polyacrylic, a polyester, a polyamide, a polyurethane, a polyvinylidene chloride, a chlorinated polyolefin, a rubber, a polycarbodiimide, a silane, or a combination thereof.

Examples of suitable polyacrylic film-forming polymers are available under the trade designations JONCRYL from BASF Corp. (Florham Park, N.J.) and PARALOID from Dow Chemical (Midland, Mich.). Examples of suitable polyacrylic film-forming polymers are also disclosed in U.S. Pat. No. 5,602,202 (Groves), particularly Example 1 of this patent.

Examples of suitable polyester film-forming polymers are available under the trade designations VITEL from Bostik Inc. (Wauwatosa, Wis.) and EASTEK (a waterborne dispersion of polyester) from Eastman Chemical (Kingsport, Tenn.).

Examples of suitable polyamide film-forming polymers are available under the trade designation TECHNOMELT from Henkel Corp. (Rocky Hill, Conn.) (formerly available under the trade designation MACROMELT).

Examples of suitable polyurethane film-forming polymers are available under the trade designations NEOREZ from DSM (Wilmington, Mass.) and U-SERIES PUD from Alberdingk (Greensboro, N.C.).

Examples of suitable polyvinylidene chloride film-forming polymers are available under the trade designation SERFENE from Owensboro Specialty Polymer (Owensboro, Ky.). Examples of suitable chlorinated polyolefin film-forming polymers are available under the trade designations “CP-343-3” (solvent-borne) and “CP347W” (water-borne), both from Eastman Chemical (Kingsport, Tenn.).

Examples of suitable rubber film-forming polymers are available under the trade designations KRATON from Kraton Polymers (Houston, Tex.) and BUTOFAN (WB dispersion) from BASF Corp. (Florham Park, N.J.). Examples of suitable polycarbodiimide film-forming polymers are available under the trade designations CARBODILITE from Nisshinbo Chemical (Sterling Heights, Mich.) and ZOLDINE from Dow Chemical (Midland, Mich.).

Examples of suitable silanes are available under the trade designation SILQUEST from Momentive (Columbus, Ohio), as well as materials available from Gelest (Morrisville, Pa.). Such exemplary silanes are monomeric in nature with molecular weights of 150 to 500 grams/mole. They may condense upon coating and drying and form a network, but the materials themselves are not polymers. Two of the more commonly used silanes in priming are those available under the trade designation SILQUEST A-187 (glycidol propyl trimethoxysilane) and SILQUEST A-1110 (gamma-aminopropyl trimethoxysilane), both of which are available from Momentive. In certain embodiments, the primer coating includes a mixture of a polyacrylic copolymer and a chlorinated polyolefin (such as that available under the tradename PRIMER 94 from 3M Company, St. Paul, Minn.).

In certain embodiments, the primer coating also includes an additive selected from silica, a crosslinker (e.g., an isocyanate, aziridine, or melamine crosslinker), a monomeric silane, a plasticizer, a tackifer, and a combination thereof

In certain embodiments, the primer coating is a solvent cast film (i.e., deposited out of a solvent-based primer composition) or an aqueous-solventless cast film (i.e., deposited out of an aqueous-based primer composition).

In certain embodiments, the primer coating is deposited out of a solvent-based primer composition. In certain embodiments, the solvent-based primer composition includes at least 5 parts, or at least 10 parts polymer, based on the total weight of the primer composition (including solvent and optional additives). In certain embodiments, the solvent-based primer composition includes up to 60 parts, up to 40 parts, or up to 30 parts polymer, based on the total weight of the primer composition (including solvent and optional additives).

Techniques for applying a primer to a polymeric reinforcement film layer are well known to those skilled in the art. Examples include extrusion coating, roll coating, knife coating, rod coating, blade coating, curtain coating, or any suitable method. A representative technique is described in the Examples Section.

In certain embodiments, the water-activatable adhesive layer disposed on the primer-coated surface of the polymeric reinforcement film is a solvent cast film, an aqueous-solventless cast film, or a molten film. A wide variety of conventional water-activatable adhesives for box sealing or carton sealing tapes (also referred to as packaging tapes) can be used in the water-activated tapes of the present disclosure.

Exemplary water-activatable adhesives include starch-based adhesives such as an adhesive derived from corn, sorghum, wheat, sago, tapioca, legumes, barley, rice, and/or potatoes. Examples of exemplary starch-based remoistenable adhesives are available from HB Fuller (St. Paul, Minn.) under the trade designation FULLSEAL ENVELOPE GUM PWE2334. Other exemplary water-activatable adhesives include polyvinyl acetate-based, remoistenable adhesives, such as those available from HB Fuller (St. Paul, Minn.) under the trade designation FULLSEAL ENVELOPE GUM X3305113.

In certain embodiments, the water-activatable adhesives include fillers and other optional additives.

In certain embodiments, the water-activatable adhesive layer has a thickness of at least 0.1 mil (2.5 micrometers). In certain embodiments, the water-activatable adhesive layer has a thickness of up to 2.5 mils (63.5 micrometers).

Techniques for applying a water-activatable adhesive to a primer-coated polymeric reinforcement film layer are well known to those skilled in the art. Examples include extrusion coating, roll coating, knife coating, rod coating, blade coating, curtain coating, or any suitable method. A representative technique is described in the Examples Section.

In certain embodiments, the water-activated (non-fiber-reinforced) tapes of the present disclosure have a thickness of at least 2 mil (50 micrometers). In certain embodiments, the water-activated tapes of the present disclosure have a thickness of up to 10 mils (250 micrometers).

In certain embodiments, water-activated tapes of the present disclosure have a peel adhesion strength between the water-activatable adhesive layer and the polymeric reinforcement film layer of greater than 100 grams/25.4 millimeters, or greater than 400 grams/25.4 millimeters.

### Illustrative Embodiments

The following embodiments are intended to be illustrative of the present disclosure and not limiting.

Embodiment 1 is a water-activated tape comprising: a laminate comprising a polymeric reinforcement film layer having two major surfaces, and a paper layer bonded to one major surface of the polymeric reinforcement film; a primer coating disposed on the major surface of the polymeric reinforcement film layer of the laminate opposite the paper layer; and a water-activatable adhesive layer disposed on the primer-coated surface of the polymeric reinforcement film.

Embodiment 2 is the water-activated tape of embodiment 1 wherein the paper layer and the polymeric reinforcement film layer are bonded together through extrusion lamination.

Embodiment 3 is the water-activated tape of embodiment 1 wherein the paper layer and the polymeric reinforcement film layer are bonded together with an adhesive.

Embodiment 4 is the water-activated tape of embodiment 3 wherein the paper layer and the polymeric reinforcement film layer are bonded together with a pressure sensitive adhesive.

Embodiment 5 is the water-activated tape of embodiment 4 wherein the paper layer and the polymeric reinforcement film layer are bonded together with an acrylic-based pressure sensitive adhesive (e.g., an emulsion-based acrylic pressure sensitive adhesive).

Embodiment 6 is the water-activated tape of any one of embodiments 1 through 5 wherein the paper layer comprises a creped paper, a non-creped paper, or a release paper.

Embodiment 7 is the water-activated tape of embodiment 6 wherein the paper layer comprises a Kraft paper.

Embodiment 8 is the water-activated tape of embodiment 7 wherein the Kraft paper is a creped NBSK (Northern Bleached Softwood Kraft), such as a 20 to 57 pound Kraft paper.

Embodiment 9 is the water-activated tape of any of embodiments 1 through 8 wherein the paper layer has a thickness of at least 25 micrometers.

Embodiment 10 is the water-activated tape of any of embodiments 1 through 9 wherein the paper layer has a thickness of up to 200 micrometers.

Embodiment 11 is the water-activated tape of any of embodiments 1 through 10 wherein the polymeric reinforcement film layer comprises an oriented film.

Embodiment 12 is the water-activated tape of embodiment 11 wherein the oriented film is biaxially oriented or monoaxially oriented.

Embodiment 13 is the water-activated tape of embodiment 12 wherein the oriented film is biaxially oriented.

Embodiment 14 is the water-activated tape of any of embodiments 1 through 13 wherein the polymeric reinforcement film layer comprises a polyolefin, a nylon, a polyester, or a co-polyester.

Embodiment 15 is the water-activated tape of embodiment 14 wherein the polymeric reinforcement film layer comprises biaxially oriented polypropylene (BOPP), biaxially oriented polyethylene terephthalate (PET), or biaxially oriented polylactide (PLA).

Embodiment 16 is the water-activated tape of any of embodiments 1 through 15 wherein the polymeric reinforcement film layer has a thickness of at least 0.5 mil (12.7 micrometers), or at least 1.0 mil (25 micrometers).

Embodiment 17 is the water-activated tape of any of embodiments 1 through 16 wherein the polymeric reinforcement film layer has a thickness of up to 2 mils (50.8 micrometers).

Embodiment 18 is the water-activated tape of any of embodiments 1 through 17 wherein the polymeric reinforcement film layer comprises an additive selected from a UV inhibitor, antioxidant, pigment, and antistatic agent.

Embodiment 19 is the water-activated tape of any of embodiments 1 through 18 wherein the water-activatable adhesive layer is a solvent cast film, an aqueous-solventless cast film, or a molten film.

Embodiment 20 is the water-activated tape of any of embodiments 1 through 19 wherein the water-activatable adhesive layer comprises a starch-based adhesive (e.g., an adhesive derived from from corn, sorghum, wheat, sago, tapioca, legumes, barley, rice, and/or potatoes).

Embodiment 21 is the water-activated tape of any of embodiments 1 through 19 wherein the water-activatable adhesive layer comprises a polyvinyl acetate-based, remoistenable adhesive.

Embodiment 22 is the water-activated tape of any of embodiments 1 through 21 wherein the water-activatable adhesive layer has a thickness of at least 0.1 mil (2.5 micrometers).

Embodiment 23 is the water-activated tape of any of embodiments 1 through 22 wherein the water-activatable adhesive layer has a thickness of up to 2.5 mils (63.5 micrometers).

Embodiment 24 is the water-activated tape of any of embodiments 1 through 23 wherein the primer coating comprises a film-forming polymer and optionally an additive.

Embodiment 25 is the water-activated tape of any of embodiments 1 through 24 wherein the primer coating comprises a polymer having a wide range of molecular weights (e.g., 10,000-500,000 Daltons).

Embodiment 26 is the water-activated tape of any of embodiments 1 through 25 wherein the primer coating comprises a polymer having a wide range of Tg's (e.g., −30° C. to 40° C.).

Embodiment 27 is the water-activated tape of any of embodiments 1 through 26 wherein the primer coating comprises a polyacrylic, a polyester, a polyamide, a polyurethane, a polyvinylidene chloride, a chlorinated polyolefin, a rubber, a polycarbodiimide, a silane, or a combination thereof.

Embodiment 28 is the water-activated tape of embodiment 27 wherein the primer coating comprises a mixture of a polyacrylic copolymer and a chlorinated polyolefin.

Embodiment 29 is the water-activated tape of any of embodiments 1 through 28 wherein the primer coating comprises an additive selected from silica, a crosslinker (e.g., an isocyanates, aziridine, and melamine crosslinker), a monomeric silane, a plasticizer, a tackifer, or a combination thereof.

Embodiment 30 is the water-activated tape of any of embodiments 1 through 29 wherein the primer coating is a solvent cast film or an aqueous-solventless cast film.

Embodiment 31 is the water-activated tape embodiment 30 wherein the primer coating is deposited out of a solvent-based primer composition.

Embodiment 32 is the water-activated tape of embodiment 31 wherein the solvent-based primer composition comprises 5 parts to 60 parts by weight of the polymer, or 10 parts to 40 parts polymer, or 10 parts to 30 parts polymer, with the remainder of the primer composition being solvent and optional additives.

Embodiment 33 is the water-activated tape of any one of embodiments 1 through 32 wherein the polymeric reinforcement film layer is corona treated.

Embodiment 34 is the water-activated tape of embodiment 33 wherein the polymeric reinforcement film layer is air-corona treated.

Embodiment 35 is the water-activated tape of any of embodiments 1 through 34 wherein the tape has a thickness of 50 to 250 micrometers.

Embodiment 36 is the water-activated tape of any one of embodiments 1 through 35 which has a peel adhesion strength between the water-activatable adhesive layer and the polymeric reinforcement film of greater than 100 grams/25.4 millimeters of, or greater than 400 grams/25.4 millimeters of.

### Examples

The following examples are given to illustrate, but not limit, the scope of this disclosure. As used herein, all parts and percentages are by weight unless otherwise specified. All commercial materials were used as obtained from the vendor. Unless otherwise specified, materials can be obtained from Sigma-Aldrich Corp. (St. Louis, Mo.).

### Materials

| DESIGNATION | DESCRIPTION |
|---|---|
| Film 1 | Polyethylene Terephthalate (PET) film, having a thickness of 50 micrometers |
| | and pre-treated on one side to promote adhesion, available under the trade |
| | designation MELINEX 453 from DuPont Teijin Films US, Chester, VA. |
| 311 Tape | A box sealing tape having a biaxially oriented polypropylene (BOPP) |
| | backing and a pressure sensitive acrylic adhesive tape, with a backing |
| | thickness of 28 micrometers and a total thickness of 52 micrometers, |
| | available under the trade designation SCOTCH BOX SEALING TAPE 311 |
| | from 3M Company, St Paul, MN. |
| 40# Paper layer | A brown Kraft paper having a machine finish on both sides and a thickness of |
| | 70 micrometers, available under the trade designation 40 pound MF from |
| | Expera Specialty Solutions, Mosinee, WI. |
| Adhesive 1 | A water-based adhesive, 48% solids in water, available under the trade |
| | designation FULLSEAL ENVELOPE GUM X3305IB by HB Fuller, St Paul, |
| | MN. |
| Adhesive 2 | A water-based adhesive, 68% solids in water, available under the trade |
| | designation FULLSEAL ENVELOPE GUM PWE2334 by HB Fuller, St |
| | Paul, MN. |
| NEOREZ R-600 | A bluish hazy liquid of an aliphatic urethane dispersion, designed for filmic |
| | primer applications, 33% solids, available under the trade designation |
| | NEOREZ R-600 from DSM Coating Resins, Wilmington, MA. |
| PRIMER 94 | A proprietary mixture of an acrylic copolymer and chlorinated polyolefin, |
| | approximately 6% solids in a mixture of organic solvents, available under the |
| | trade designation 3M TAPE PRIMER 94 from 3M Company, St. Paul, MN. |
| VAZO 67 | 2,2′-Azobis(2-methylbutyronitrile), a thermally activated polymerization |
| | initiator, available under the trade designation VAZO 67 from The Chemours |
| | Company, Wilmington, DE. |
| BUTOFAN NS- | An approximate 51% solids, anionic aqueous dispersion of carboxylated |
| 222 | styrene-butadiene copolymer having a pH of 8.8, available under the trade |
| | designation BUTOFAN NS-222 from BASF Corporation, Florham Park, NJ. |
| SUPERCHLON | A liquid, dispersion of a waterborne chlorinated polyolefin having a pH of |
| E-480T | between 6 and 9, 30% solids, available under the trade designation |
| | SUPERCHLON E-480T from Nippon Paper Industries Company, Limited, |
| | Tokyo, Japan. |
| TECHNOMELT | A high performance thermoplastic hot melt adhesive based on polyamide. |
| 6240 | available under the trade designation TECHNOMELT (formerly |
| | MACROMELT) 6240 from Henkel Corporation, Rocky Hill, CT. |
| FRWAT1 | A three-way fiberglass reinforced natural colored Kraft carton sealing tape |
| | having a total thickness 0.0057 inch (145 micrometers), a backing made of |
| | two plies ply of natural Kraft with fiberglass and a high melt index |
| | polypropylene based copolymer therebetween, and a water-activatable |
| | adhesive of a chemically grafted starch-based copolymer on one outer surface |
| | of the backing, available under the trade designation LEGEND NATURAL |
| | REINFORCED WATER-ACTIVATED TAPE from Intertape Polymer |
| | Group, Sarasota, FL. |
| FRWAT2 | A three-way fiberglass reinforced natural colored Kraft carton sealing tape |
| | having a total thickness of 0.0061 inches (155 micrometers), a backing made |
| | of two plies of natural Kraft paper and one ply natural Kraft paper with |
| | fiberglass and a high melt index polypropylene based copolymer |
| | therebetween, and a water-activatable adhesive of a chemically grafted |
| | starch-based copolymer on one outer surface of the backing, available under |
| | the trade designation MEDALLION NATURAL REINFORCED WATER- |
| | ACTIVATED TAPE from Intertape Polymer Group, Sarasota, FL. |
| FRWAT3 | A tape used for box sealing and other packaging applications having a |
| | fiberglass reinforced paper layer, a high tack water-activatable, modified |
| | starch based adhesive system, and a thickness of 0.005 inches (127 |
| | micrometers), available under the traded designation LIGHT DUTY |
| | REINFORCED WATER-ACTIVATED TAPE 6145 KRAFT from 3M |
| | Company, St. Paul, MN. |

### Test Methods

### Peel Adhesion Strength Between Film Backing and Adhesive

After conditioning for at least two hours at 72° F. and 50% relative humidity (RH), a tape sample measuring 10.5 inches long by 0.5 inches wide (267 centimeters by 1.27 centimeters) was attached to the horizontal platen surface of peel tester (Model SP 2000 IMass Peel Tester, available from IMASS Incorporated, Accord, Mass.) using a double-coated pressure sensitive adhesive tape, with the backing of the tape sample adhered to the double coated tape and the adhesive surface of the tape sample facing upward and exposed. Next, 3M POLYESTER FILM ELECTRICAL TAPE 56 was applied to the exposed adhesive surface of the tape sample such that the adhesive layers of each tape were bonded together. Approximately two inches (5.1 centimeters) of the TAPE 56 extended beyond the end of the tape sample; this was attached to the peel tester. The peel test was run at 72° F. and 50% RH at an angle of 180° and a rate of 90 inches/minute (228 centimeters/minute). Data acquisition was begun two seconds after starting the test, the acquisition time was five seconds, and the average peel adhesion force was recorded. The results were normalized to a one inch (2.54 centimeters) width. Two tape samples were run and the average value reported in grams/inch (grams/25.4 millimeters).

The peel adhesion strength between the film-based backing and adhesive of a tape sample is a measure of the peel adhesion strength between the coated adhesive (Adhesive 1 or Adhesive 2) and the film surface of that specific sample. With the use of a high peel adhesion strength test tape (3M POLYESTER FILM ELECTRICAL TAPE 56), the coated adhesive was removed from the film-based backing. If this peel removal could be initiated then a peel adhesion strength was able to be measured directly and reported.

In some cases it was not possible to initiate peel removal of the adhesive from the film-based backing. When this occurred the peel adhesion strength recorded represented the adhesion between the adhesive of the tape sample and the adhesive of TAPE 56. This indicated the peel adhesion strength between the adhesive and film-based backing of the tape sample was greater than the peel adhesion strength between adhesive of the tape sample and the adhesive of TAPE 56. When this occurred the peel adhesion strength between the film-based backing and adhesive of the tape sample was reported as greater than the measured value.

### Box Drop Test

A box drop test was carried out on a single wall corrugate box measuring 17.5 inches long by 11.4 inches wide by 8.5 inches high (44.5 centimeters by 29.0 centimeters by 21.6 centimeters) having an Edge Crush Test (ECT) value of 32 pounds/inch (5.71 kilograms/centimeter) and a gross weight limit of 65 pounds (29.5 kilograms) (available from Liberty Carton Company, Minneapolis, Minn.) generally according to the International Safe Transit Authority (ISTA, East Lansing, Mich.) 1 Series: “Non-Simulation Integrity Performance Test Procedures” (1A: Version 2001, Editorial Change 2008), Drop Shock Test, using a Lansmont Model PDT-56ED Drop Tester (available from Lansmont Corporation, Monterey, Calif.).

Water-activated tape was uniformly wetted with water as it was dispensed from a 3M Model W200 ELECTRIC WATER-ACTIVATED TAPE DISPENSER (available from 3M Company, St Paul, Minn.). Within 15 seconds of dispensing, a length of 24 inches (61 centimeters) of the wetted tape was applied to a corrugate box, whose long bottomside flaps had been closed over its short bottomside flaps, such that the length of the tape covered the length of the seam between the two long flaps and wrapped around the end edges, with the adhesive surface in contact with the box surface. The length of tape extending around the end edges was no less than 2.5 inches (6.4 centimeters) and no more than 4 inches (10.2 centimeters) long. The tape was smoothed down with slight hand pressure to seal the bottom of the box. The portion of tape that extended over the end edge and down the end surface of the box is referred to as the tape leg. The box was then filled with 31 pounds (14.07 kilograms) of books, which filled approximately 90% of the box volume. The long topside flaps were then closed over its short topside flaps, and sealed with another 24 inch length of the water-activated tape in the same manner as the bottomside. This resulted in four tape legs on a box: one at each of the two top edges and one at each of the two bottom edges. The drop test sequence was started no sooner than 5 minutes, but no longer than 10 minutes after sealing the box. The packed box was dropped from a height of 36 inches (91.4 centimeters) ten times in the sequence specified by the test method, so as to apply standardized stress to the four tape legs.

After completion of ten drops the tape legs were examined for failures. Tape legs that split or separated completely across the tape width in the area around the edge, or down the length of the tape covering the seam between the two long flaps were counted as failures. For fiber-reinforced paper tapes, tape legs where the paper split completely leaving only a few intact fibers were also counted as failures. For paper/film laminated tapes, any split which exceeded 50% of the total tape width was listed as a failure. Two boxes were prepared with fresh tape and drop tested for each tape sample resulting in a total of eight tape legs being evaluated (four per box as described above). Box Drop data is presented as the number of failures per 8 tape legs. For example, 2/8 indicates two failures were observed out of 8 tape legs total.

### Primers

### Primer 1

Primer 1 was prepared by diluting NEOREZ R-600 to 5% solids with deionized water.

### Primer 2

3M TAPE PRIMER 94 was used as Primer 2.

### Primer 3

Primer 3 was prepared in the following manner. A reactor was charged with 84 grams of butyl methacrylate, 18 grams of iso-octyl acrylate, 18 grams of tert-butyl amino ethyl methacrylate, and 180 grams of ethyl acetate. VAZO 67, 0.96 grams was then added and the solution was purged with nitrogen and sealed. The reactor was then heated at 65° C. for 46 hours after which it was allowed to cool to ambient temperature. The % solids and intrinsic viscosity were measured and found to be 40.0% and 0.38 respectively. This was then diluted with ethyl acetate to 5 wt-% solids.

### Primer 4

Primer 4 was prepared by combining 14.1 grams of BUTOFAN NS-222, 2.7 grams of SUPERCHLON E-480T), and 63.2 grams of deionized water to produce a 10% solids coating solution.

### Primer 5

Primer 5, a polyurethane based primer at 5 wt-% solids in methyl ethyl ketone (MEK), was prepared as described in Example 14 of WO 2016/118399.

### Primer 6

Primer 6, an acrylic based primer, was prepared as described in Example 10 of U.S. Pat. No. 5,461,125 and then diluted to 5 wt-% solids with deionized water.

### Primer 7

Primer 7 was prepared by dissolving TECHNOMELT 6240 (formerly MACROMELT 6240) in an 85:15 (w:w) mixture of isopropanol and toluene to form a 10% solids solution.

### Paper/Film Tape Preparation

A Paper/Film tape was prepared by laminating Tape 311 to 40# Paper layer at 72° F. (22° C.) using a laminator with a rubber and a steel nip roll with a nip pressure of 20 pounds/square inch (138 KiloPascals). When employed, corona treatment in air of the exposed film backing of Tape 311 was then carried out using a Model # SN-8S-SL Air Corona Treater (Thermotron Industries, Holland, Mich.) at 30 feet/minute (9.1 meters/minute) and 0.6 kilowatts power to provide a treatment level of approximately 1.0 Joules/square centimeter. This was followed by application of a primer solution, where used, to the exposed surface of the film backing using a #6 Mayer rod and dried at 50° C. for 5 minutes to give a dried primer thickness of between 0.75 and 1.5 micrometers. Next, Adhesive 1 was coated onto the exposed film backing with a BYK 4 inch (102 centimeter) coating square (available from BYK-Gardiner USA, Columbia, Md.) with a 50 micrometer gap and dried at 50° C. for 5 minutes to give a dried coating thickness of 18 micrometers. Alternatively, Adhesive 2 was coated in the same manner as Adhesive 1 with the following modification. A 38 micrometer gap was employed. The dried coating thickness was 18 micrometers.

A Paper/Film Tape having, in order, a paper layer, the adhesive of Tape 311, the film backing of Tape 311, optional corona treatment of the side of the film backing of Tape 311 opposite that of the adhesive, optional primer coating on the side film backing of Tape 311 opposite that of the adhesive, and Adhesive 1 or Adhesive 2 on the side of the film backing of Tape 311 opposite that of the adhesive of Tape 311 was thus obtained. The resulting tape constructions were evaluated for peel adhesion strength between the film backing and the coated adhesive (Adhesive 1 or Adhesive 2) and box drop. The results are shown in Tables 1 and 2 below.

### Film Tape Preparation

A Film-backed tape was prepared as described for Paper/Film Tape Preparation above with the following modifications. Film 1 was used in place of the paper/film backing. In addition, the various primer/adhesive combinations were coated on either the untreated or treated side of Film 1.

TABLE 1
Peel Adhesion Strength Between Film Backing and Adhesive

| | | Surface | | Water-activatable | Peel Adhesion |
|---|---|---|---|---|---|
| Example | Substrate | Treatment | Primer | Adhesive | (g/25.4 mm) |
| C1 | Paper/Film | None | None | Adhesive 1 | 23 |
| | Laminate | | | | |
| C2 | Paper/Film | None | None | Adhesive 2 | 18 |
| | Laminate | | | | |
| C3 | Paper/Film | Air Corona | None | Adhesive 1 | 85 |
| | Laminate | | | | |
| C4 | Paper/Film | Air Corona | None | Adhesive 2 | 16 |
| | Laminate | | | | |
| 1 | Paper/Film | None | Primer 1 | Adhesive 1 | 31 |
| | Laminate | | | | |
| 2 | Paper/Film | None | Primer 2 | Adhesive 1 | 462 |
| | Laminate | | | | |
| 3 | Paper/Film | None | Primer 3 | Adhesive 1 | 26 |
| | Laminate | | | | |
| 4 | Paper/Film | None | Primer 4 | Adhesive 1 | Primer coating |
| | Laminate | | | | de-wetted from |
| | | | | | film, uniform |
| | | | | | primer coating |
| | | | | | could not be |
| | | | | | obtained |
| 5 | Paper/Film | None | Primer 5 | Adhesive 1 | 44 |
| | Laminate | | | | |
| 6 | Paper/Film | None | Primer 6 | Adhesive 1 | Primer coating |
| | Laminate | | | | de-wetted from |
| | | | | | film, uniform |
| | | | | | primer coating |
| | | | | | could not be |
| | | | | | obtained |
| 7 | Paper/Film | None | Primer 7 | Adhesive 1 | 45 |
| | Laminate | | | | |
| 8 | Paper/Film | None | Primer 1 | Adhesive 2 | 32 |
| | Laminate | | | | |
| 9 | Paper/Film | None | Primer 2 | Adhesive 2 | >1741 |
| | Laminate | | | | |
| 10 | Paper/Film | None | Primer 3 | Adhesive 2 | 36 |
| | Laminate | | | | |
| 11 | Paper/Film | None | Primer 4 | Adhesive 2 | Primer coating |
| | Laminate | | | | de-wetted from |
| | | | | | film, uniform |
| | | | | | primer coating |
| | | | | | could not be |
| | | | | | obtained |
| 12 | Paper/Film | None | Primer 5 | Adhesive 2 | 115 |
| | Laminate | | | | |
| 13 | Paper/Film | None | Primer 6 | Adhesive 2 | Primer coating |
| | Laminate | | | | de-wetted from |
| | | | | | film, uniform |
| | | | | | primer coating |
| | | | | | could not be |
| | | | | | obtained |
| 14 | Paper/Film | None | Primer 7 | Adhesive 2 | 106 |
| | Laminate | | | | |
| 15 | Paper/Film | Air Corona | Primer 1 | Adhesive 1 | 688 |
| | Laminate | | | | |
| 16 | Paper/Film | Air Corona | Primer 2 | Adhesive 1 | 865 |
| | Laminate | | | | |
| 17 | Paper/Film | Air Corona | Primer 3 | Adhesive 1 | 783 |
| | Laminate | | | | |
| 18 | Paper/Film | Air Corona | Primer 4 | Adhesive 1 | 578 |
| | Laminate | | | | |
| 19 | Paper/Film | Air Corona | Primer 5 | Adhesive 1 | 439 |
| | Laminate | | | | |
| 20 | Paper/Film | Air Corona | Primer 6 | Adhesive 1 | 218 |
| | Laminate | | | | |
| 21 | Paper/Film | Air Corona | Primer 7 | Adhesive 1 | 281 |
| | Laminate | | | | |
| 22 | Paper/Film | Air Corona | Primer 1 | Adhesive 2 | >1769 |
| | Laminate | | | | |
| 23 | Paper/Film | Air Corona | Primer 2 | Adhesive 2 | >1687 |
| | Laminate | | | | |
| 24 | Paper/Film | Air Corona | Primer 3 | Adhesive 2 | >1131 |
| | Laminate | | | | |
| 25 | Paper/Film | Air Corona | Primer 4 | Adhesive 2 | >1080 |
| | Laminate | | | | |
| 26 | Paper/Film | Air Corona | Primer 5 | Adhesive 2 | >1247 |
| | Laminate | | | | |
| 27 | Paper/Film | Air Corona | Primer 6 | Adhesive 2 | >1721 |
| | Laminate | | | | |
| C5 | Film 1 | Untreated | None | Adhesive 1 | 41 |
| C6 | Film 1 | Untreated | None | Adhesive 2 | Too low to |
| | | | | | measure |
| C7 | Film 1 | Treated | None | Adhesive 1 | 50 |
| C8 | Film 1 | Treated | None | Adhesive 2 | 16 |
| 28 | Film 1 | Untreated | Primer 1 | Adhesive 1 | 132 |
| 29 | Film 1 | Untreated | Primer 1 | Adhesive 2 | >1732 |
| 30 | Film 1 | Treated | Primer 1 | Adhesive 1 | 176 |
| 31 | Film 1 | Treated | Primer 1 | Adhesive 2 | >1854 |
| 32 | Film 1 | None | Primer 2 | Adhesive 1 | 845 |
| 33 | Film 1 | Untreated | Primer 2 | Adhesive 2 | >1585 |
| 34 | Film 1 | Treated | Primer 2 | Adhesive 1 | 1012 |
| 35 | Film 1 | Treated | Primer 2 | Adhesive 2 | >1854 |

Comparative Examples C1-C4, are water-activatable adhesives coated directly on the film side of a paper/film backing, the film surface being a biaxially oriented polypropylene (BOPP). Without primer to enhance the peel adhesion strength between the adhesive and film, the peel force values are less than 100 grams/25.4 millimeters, even if the BOPP film surface was corona treated, as shown in C3 and C4.

Examples 1-14 show the result of coating various primers on the corona treated film surface of the BOPP film. In some instances the primer coating solutions significantly de-wetted when coated on untreated BOPP. In these cases, a uniform primer coating was not obtained and tape samples were unable to be made, as shown in Examples 4, 6, 11 and 13. Example 2 and 9 using Primer 2 resulted in a significant increase in peel adhesion strength, with values greater than 400 grams/25.4 millimeters. Examples 12 and 14 showed a moderate increase in peel adhesion strength, with values greater than 100 grams/25.4 millimeters. The remainder of examples (1, 3, 5, 7, 8 and 10) exhibited a lesser increase in peel adhesion strength.

Examples 15-27 show the result of coating various primers on the surface of the BOPP film. For all the combinations of primers/corona treatment/Adhesive 1 (or Adhesive 2) shown, the peel adhesion strengths are significantly greater than 100 grams/25.4 millimeters.

Comparative Examples C5-C8 are similar to C1-C4, except Adhesive 1 and 2 were coated directly onto Film 1. No primer was coated on Film 1 prior to coating either Adhesive 1 or Adhesive 2. The peel adhesion strengths for C5-C8 were significantly less than 100 grams/25.4 millimeters.

Examples 28-35 show the result of coating Primers 1 and 2 on each side of the PET film. As with Examples 1-4 the peel adhesion strengths for both the Adhesive 1 and 2 examples was significantly increased, usually to greater than 400 grams/25.4 millimeters.

TABLE 2
Box Drop Test

| | | Box Drop |
|---|---|---|
| Example | Tape | (no. failures/8) |
| CE 9 | FRWAT 1 | 2 of 8 |
| CE 10 | FRWAT 2 | 2 of 8 |
| CE 11 | FRWAT 3 | 2 of 8 |
| 36 | Ex. 15 | 0 of 8 |
| 37 | Ex. 16 | 1 of 8 |

A drop height of 36 inches (91.4 cm) and a weight of 31 pounds (lbs) (14.07 kg) were used for this testing. These parameters were chosen as they generated failures with commonly used tapes, but they were not so severe as to cause 100% failure when these tapes were tested. The observed failures reported in the results below occurred at the edge where the top (or bottom) surface met the end surface.

Comparatives C9-C11 were fiber-reinforced tapes, showed 2 leg failures out of 8. Examples 36 and 37, which were paper/film laminate tapes, resulted in fewer tape leg failures under these test conditions.

The referenced descriptions contained in the patents, patent documents, and publications cited herein are incorporated by reference in their entirety as if each were individually incorporated. Various unforeseeable modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only, with the scope of the disclosure intended to be limited only by the claims set forth herein as follows.

1. A water-activated tape comprising:
a laminate comprising a polymeric reinforcement film layer having two major surfaces, and a paper layer bonded to one major surface of the polymeric reinforcement film;
a primer coating disposed on the major surface of the polymeric reinforcement film layer of the laminate opposite the paper layer; and
a water-activated adhesive layer disposed on the primer-coated surface of the polymeric reinforcement film.

2. The water-activated tape of claim 1 wherein the paper layer and the polymeric reinforcement film layer are bonded together with a pressure sensitive adhesive.

3. The water-activated tape of claim 2 wherein the paper layer and the polymeric reinforcement film layer are bonded together with an acrylic-based pressure sensitive adhesive.

4. The water-activated tape of claim 1 wherein the paper layer comprises a creped paper, a non-creped paper, or a release paper.

5. The water-activated tape of claim 1 wherein the polymeric reinforcement film layer comprises a biaxially oriented film.

6. The water-activated tape of claim 1 wherein the polymeric reinforcement film layer comprises a polyolefin, a nylon, a polyester, or a co-polyester.

7. The water-activated tape of claim 6 wherein the polymeric reinforcement film layer comprises biaxially oriented polypropylene, biaxially oriented polyethylene terephthalate, or biaxially oriented polylactide.

8. The water-activated tape of claim 1 wherein the polymeric reinforcement film layer has a thickness of 0.5 mil (12.7 micrometers) to 2 mils (50.8 micrometers).

9. The water-activated tape of claim 1 wherein the water-activatable adhesive layer comprises a starch-based adhesive.

10. The water-activated tape of claim 1 wherein the water-activatable adhesive layer comprises a polyvinyl acetate-based, remoistenable adhesive.

11. The water-activated tape of claim 1 wherein the water-activatable adhesive layer has a thickness of 0.1 mil (2.5 micrometers) to 2.5 mils (63.5 micrometers).

12. The water-activated tape of claim 1 wherein the primer coating comprises a film-forming polymer and optionally an additive.

13. The water-activated tape of claim 1 wherein the primer coating comprises a polyacrylic, a polyester, a polyamide, a polyurethane, a polyvinylidene chloride, a chlorinated polyolefin, a rubber, a polycarbodiimide, a silane, or a combination thereof.

14. The water-activated tape of claim 13 wherein the primer coating comprises a mixture of a polyacrylic copolymer and a chlorinated polyolefin.

15. The water-activated tape of claim 1 wherein the primer coating is deposited out of a solvent-based primer composition.

16. The water-activated tape of claim 15 wherein the solvent-based primer composition comprises 5 parts to 60 parts by weight of the base polymer, with the remainder of the primer composition being solvent and optional additives.

17. The water-activated tape of claim 1 wherein the polymeric reinforcement film layer is corona treated.

18. The water-activated tape of claim 1 which has a peel adhesion strength between the water-activatable adhesive layer and the polymeric reinforcement film of greater than 100 grams/25.4 millimeters.

19. The water-activated tape of claim 1 which has a peel adhesion strength between the water-activatable adhesive layer and the polymeric reinforcement film of greater than 400 grams/25.4 millimeters.

20. The water-activated tape of claim 1 wherein the tape has a thickness of 50 to 250 micrometers.
